(19) United States
(12) Patent Application Publication
(10) Pub. No.: US 2025/0136388 A1
(43) Pub. Date: May 1, 2025

(54) Cell Packaging Device

(71) Applicant: LG Energy Solution, Ltd., Seoul (KR)

(72) Inventors: Seung Jin Hwang, Daejeon (KR); Ju Hwan Baek, Daejeon (KR); Jin Soo Lee, Daejeon (KR); Seung Bae Lee, Daejeon (KR); Won Seok Choi, Daejeon (KR); Seok In Hong, Daejeon (KR); Duk Keun Oh, Daejeon (KR)

(73) Assignee: LG Energy Solution, Ltd., Seoul (KR)

(21) Appl. No.: 18/684,380

(22) PCT Filed: Mar. 7, 2023
(86) PCT No.: PCT/KR2023/003067

§ 371 Date: Feb. 16, 2024

(30) Foreign Application Priority Data
Mar. 7, 2022 (KR) 10-2022-0028709

(51) Int. Cl. B65G 47/90; H01M 10/04

(52) U.S. Cl. CPC B65G 47/90; H01M 10/0404

(57) ABSTRACT

The present disclosure relates to a cell packaging device. The cell packaging device can include a cell grip unit with a cell grip part including a first member provided with a roller and a second member disposed opposite to the first member at a predetermined interval to provide an insertion space to receive a cell. A gap adjusting part of the cell grip unit can adjust a gap between the first member and the second member. A transport part of the cell packaging unit can transport the cell grip unit.

### CROSS-REFERENCE TO RELATED APPLICATIONS

The present application is a national phase entry under 35 U.S.C. § 371 of International Application No. PCT/KR2023/003067 filed on Mar. 7, 2023, which claims the benefit of priority based on Korean Patent Application No. 10-2022-0028709 dated Mar. 7, 2022, the disclosures of which are incorporated herein by reference in their entirety.

### TECHNICAL FIELD

The present application relates to a cell packaging device.

### BACKGROUND ART

A lithium secondary battery is generally manufactured by accommodating an electrode assembly (hereinafter, also referred to as a ‘cell’), in which a positive electrode (cathode), a separator, and a negative electrode (anode) are laminated, in a pouch.

Particularly, in the case of the pouch-type cell among lithium secondary batteries, the manufacturing cost is inexpensive and it has a small weight, so that demand increases.

In the manufacturing process of the pouch-type cell, the cell in which the lamination of the positive electrode, the separator, and the negative electrode has been completed is transported to the pouch in a state of being sucked into a gripper in a vacuum suction manner, and the cell gripped in the gripper is inserted into the pouch.

However, when the cells are transported in the vacuum adsorption manner, there is a problem that the cells are damaged during the process of being inserted into the pouch, and there is a problem that high-weight cells cannot be transported in the vacuum adsorption manner.

### DISCLOSURE

### Technical Problem

It is a problem to be solved by the present invention to provide a cell packaging device capable of preventing cell damage in a process of inserting cells into a pouch.

### Technical Solution

In order to solve the above problem, according to one aspect of the present invention, a cell packing device is provided, which comprises a cell grip unit comprising a cell grip part including a first member provided with a roller, a second member disposed opposite to the first member at a predetermined interval to provide an insertion space of a cell, and a gap adjusting part adjusting a gap between the first member and the second member, and a transport part transporting the cell grip unit.

Also, the gap adjusting part may be provided to adjust the gap by moving the second member.

In addition, the roller may be disposed at the entry end where the cell enters the insertion space.

Furthermore, the transport part may be provided to rotate the cell grip unit along the thickness direction or the width direction of the cell during the transport process.

Also, the transport part may comprise a plurality of rotation parts provided to rotate along the thickness direction and the width direction of the cell, respectively, and links connecting the adjacent rotation parts.

In addition, the cell packaging device may comprise a control part controlling the cell grip unit and the transport part.

The control part may transport the cell grip unit so that the cell on a cell supply part is positioned in the insertion space between the first member and the second member.

Furthermore, the control part may be provided to narrow the gap between the first member and the second member after the cell is seated on the first member.

Also, the control part may transport the cell grip unit so that the cell on a cell supply part is seated on the first member while contacting the roller.

In addition, the control part may transport the cell grip unit so that a partial region of the cell contacts the pouch in a state where the cell is gripped.

Furthermore, the control part may be provided to release the grip of the cell by widening the gap between the first member and the second member in a state where a partial region of the cell contacts the pouch.

Also, the control part may transport the cell grip unit so that when the cell grip is released, the cell is inserted into the pouch while contacting the roller.

In addition, the roller may be idle-rotatably mounted to the first member.

Furthermore, the gap adjusting part may be provided to move the second member in a direction closer to or farther from the first member.

In addition, the cell grip unit may comprise a support part connected to the transport part. Furthermore, a plurality of cell grip parts may be provided on the support part at predetermined intervals.

### Advantageous Effects

As described above, according to the cell packaging device related to at least one example of the present invention, in the process of inserting the cell into the pouch, it is possible to prevent the damage of the cell, and it is also possible to transport a high-weight cell to the pouch.

### DESCRIPTION OF DRAWINGS

FIG. 1 is a perspective diagram schematically showing a cell packaging device according to an embodiment of the present disclosure.

FIG. 2 is a perspective diagram showing the cell grip unit shown in FIG. 1.

FIG. 3 is a perspective diagram showing a first member of the cell grip unit shown in FIG. 2.

FIG. 4 is a schematic diagram showing an operating state of a cell packaging device according to an embodiment of the present disclosure.

FIG. 5 is a schematic diagram showing another operating state of the cell packing device of FIG. 4.

FIG. 6 is a schematic diagram showing another operating state of the cell packing device of FIG. 4.

FIG. 7 is a schematic diagram showing another operating state of the cell packing device of FIG. 4.

### MODE FOR INVENTION

Hereinafter, a cell packaging device according to one example of the present invention will be described in detail with reference to the drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

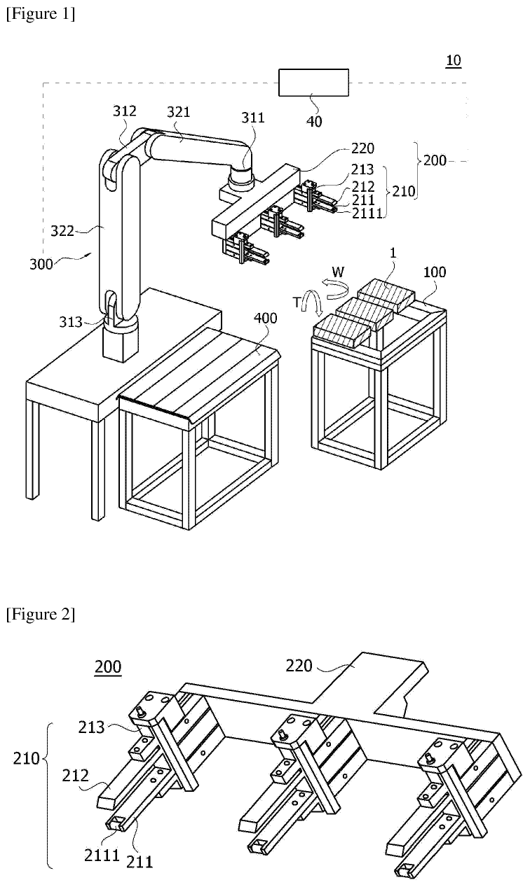

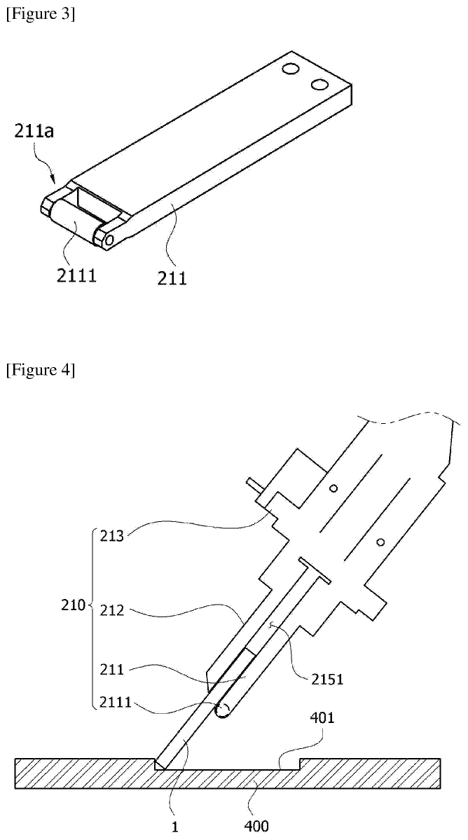

FIG. 1 is a perspective diagram schematically showing a cell packaging device (10) according to one example of the present invention, FIG. 2 is an essential part perspective diagram showing the cell grip unit (200) shown in FIG. 1, and FIG. 3 is a perspective diagram showing the first member (211) of the cell grip unit shown in FIG. 2.

FIGS. 4 to 7 are schematic diagrams for explaining one operating state of a cell packaging device according to one example of the present invention.

Referring to FIG. 1, the cell packaging device (10) related to one example of the present invention comprises a cell grip unit (200) and a transport part (300).

The cell packaging device (10) comprises a cell grip unit (200) comprising a cell grip part (210) including a first member (211) provided with a roller (2111), a second member (212) disposed opposite to the first member (211) at a predetermined interval to provide an insertion space (2151) of a cell (1) and a gap adjusting part (213) adjusting the gap between the first member (111) and the second member (212), and a transport part (300) transporting the cell grip unit (200).

Also, the cell grip unit (200) may comprise a support part (220) connected to the transport part (300). In addition, a plurality of cell grip parts (210) may be provided at predetermined intervals on the support part (220).

The cell grip unit (200) grips the cell (1) placed on a cell supply part (100), transports it to a pouch (400), and then performs a function that the cell (1) is inserted into an accommodating part (401) of the pouch (400).

The cell grip part (210) comprises a first member (211), a second member (212), and a gap adjusting part (213). The cell grip part (210) is a part directly holding the cell (1), in which a plurality of cell grip parts may be provided on the support part (220).

In addition, the support part (220) supports the cell grip part (210), and as one example, the support part (220) may be connected to the gap adjusting part (213).

The first member (211) is a member on which the cell (1) is seated, which performs a function of supporting the cell (1). The first member (211) is provided with one or more rollers (2111), where the rollers (2111) may be idle-rotatably mounted on the first member (211).

The roller (2111) performs a function of minimizing impacts applied to the cell (1) when the cell (1) is gripped or released, which may be disposed at the entry end corresponding to the roller (2111) where the cell (1) enters the insertion space (2151). At this time, in the process of inserting the cell (1) into the cell grip unit (200) or discharging the cell (1) from the cell grip unit (200), the roller (2111) may contact the cell (1), and be rotated. Accordingly, it is possible to minimize damage applied to the cell (1) when the cell is gripped or released.

Referring to FIG. 3, the first member (211) may have a plate shape, where one end of the first member (211) may be connected in a fixed state to the lower part of the gap adjusting part (213), and the roller (2111) may be provided at the other end located on the opposite side of the one end.

The second member (212) is a member for providing an insertion space of the cell (1), which may be provided to grip or release the cell (1) seated on the first member (211). To this end, the second member (212) is disposed opposite to the first member (211) at a predetermined interval.

As one example, the second member (212) may have a plate shape, where one end may be connected to an upper portion of the gap adjusting part (213).

The gap adjusting part (213) is a part adjusting the gap between the first member (211) and the second member (212), which is provided to adjust a size of the cell insertion space (2151). The gap adjusting part (213) is connected to each of the first member (211) and the second member (212).

As one example, the gap adjusting part (213) may be provided to adjust the gap between the first member and the second member by moving the second member (212). The gap adjusting part (213) may comprise a driving source, such as a motor, for moving the second member (212), and a guide rail guiding the movement of the second member (212).

In addition, the gap adjusting part (213) may be provided to move the second member (212) in a direction closer to or farther from the first member (211). Specifically, when the cell (1) on the cell supply part (100) is gripped, the gap adjusting part (213) may move the second member (212) toward the first member (211) to narrow the gap. Contrary to this, when the grip of the cell (1) is released on the pouch (400), the gap adjusting part (213) may move the second member (212) away from the first member (211).

The cell (1) is an electrode assembly in which a positive electrode (cathode), a separator, and a negative electrode (anode) are laminated.

Referring to FIG. 1, the cell (1) may be supplied from the cell supply part (100). In order to insert the cell (1) into the pouch (400), the transport part (300) performs a function of transporting the cell grip unit (200) toward the cell supply part (100) or the pouch (400).

Specifically, in order to grip the cell (1) on the cell supply part (100), the transport part (300) may transport the cell grip unit (200) to the cell supply part (100), and in order to insert the cell (1) into the pouch, it may transport the cell grip unit (200) to the pouch (400).

Referring to FIG. 1, the transport part (300) may be provided to rotate the cell grip unit (200) along the thickness direction (T) or width direction (W) of the cell (1) during the transport process.

In this specification, the term “rotation along the thickness direction of the cell” means rotation along the thickness direction using the direction perpendicular to the thickness direction of the cell as a rotation axis. Also, in this specification, the term “rotation along the width direction of the cell” means rotation along the width direction using the direction perpendicular to the width direction of the cell as an axis.

The transport part (300) may adjust the angle of the cell (1) relative to the accommodating part (401) of the pouch when the cell (1) is inserted into the pouch by rotating the cell grip unit (200).

As one example, the transport part (300) may comprise a plurality of rotation parts provided to rotate in the thickness direction (T) and the width direction (W) of the cell, respectively, and links connecting adjacent rotation parts. At this time, the number of rotation parts, the rotation angle range, and the length of the link, and the like may be adjusted according to the working environment.

Referring to FIG. 1, the plurality of rotation parts may comprise a first rotation part (311), a second rotation part (312) and a third rotation part (313). In addition, the plurality of links may comprise a first link (321) connecting the first rotation part (311) and the second rotation part (312), and a second link (322) connecting the second rotation part (312) and the third rotation part (313).

The first rotating part (311) is connected to the cell grip unit (200), which may be provided to rotate along one or more directions selected from the thickness direction and the width direction of the cell.

Also, the second rotation part (312) is connected to the first link (321) and is a part for controlling the movable range of the first link, which may be provided to rotate along the thickness direction of the cell.

In addition, the third rotation part (313) is a part for controlling the movable range of the second link (322), which may be provided to rotate along one or more directions selected from the thickness direction and the width direction of the cell. Furthermore, in the third rotation part (313), the other end located in the opposite direction to one end to which the second link (322) is connected may be connected to the installation surface on which the device is installed.

Referring to FIGS. 4 to 7, the pouch (400) comprises an accommodating part (401) in which the cell (1) is seated, where the accommodating part (401) may be formed as a recessed portion through a forming process, and the like. The cell grip unit (200) grips the cell (1) on the cell supply part (100) to transport the cell (1) to the pouch (400) in a gripped state, and then releases the grip of the cell (1) on the pouch (400), thereby allowing the cell (1) to be inserted into the accommodating part (401) of the pouch (400).

In addition, the cell packaging device (10) may comprise a control part (40) controlling the cell grip unit (200) and the transport part (300).

The control part (40) is a part controlling the operation of the cell grip unit (200) and the transport part (300), which is electrically connected to the cell grip unit (200) and the transport part (300).

Describing the process of gripping the cell (1), the control part (40) may transport the cell grip unit (200) so that the cell (1) on the cell supply part (100) is positioned in the insertion space (2151) between the first member (211) and the second member (212).

In addition, the control part (40) may be provided to narrow the gap between the first member (211) and the second member (212) after the cell (1) is seated on the first member (211). That is, the control part (40) may control the gap adjusting part (213) to move the second member (212) toward the first member (211).

At this time, the control part (40) may transport the cell grip unit (200) so that the cell (1) on the cell supply part (100) is seated on the first member (211) while contacting the roller (2111). As one example, when the transport part (300) transports the cell grip unit (200) to the cell (1) on the cell supply part (100), the first link (321) and the second link (322) may rotate along one or more directions selected from the thickness direction and the width direction of the cell. Through such a process, the entry angle and direction of the cell grip unit (200) into the cell (1) loaded on the cell supply part (100) may be adjusted.

Hereinafter, a process of releasing the grip of the cell (1) on the pouch (400) by the cell grip unit (200) will be described.

Referring to FIG. 4, the control part (40) may transport the cell grip unit (200) so that a partial region of the cell (1) contacts the pouch (400) in a state where the cell (1) is gripped by the cell grip unit (200).

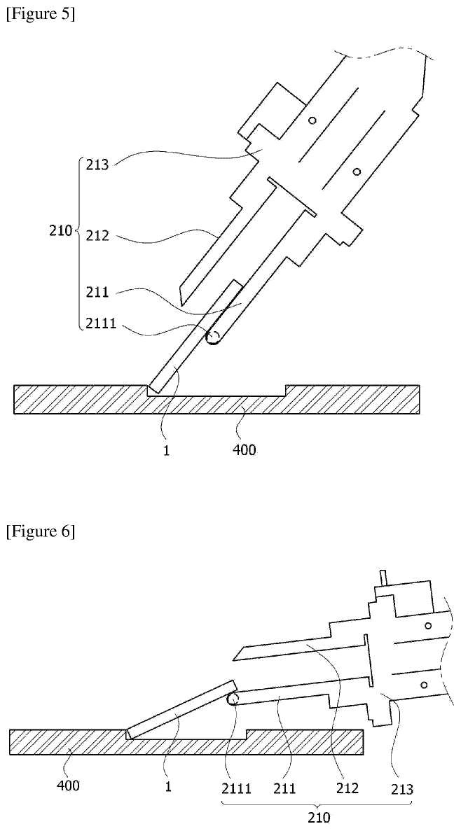

In addition, referring to FIGS. 5 to 7, the control part (40) may be provided so that the grip of the cell (1) is released by widening the gap between the first member (211) and the second member (212) in a state where a partial region of the cell (1) contacts the pouch (400). Furthermore, the control part (40) may transport the cell grip unit (200) so that when the cell grip is released, the cell (1) is inserted into the pouch (400) while contacting the roller (2111).

Referring to FIG. 5, the control part (40) may control such that in a state where the cell (1) is gripped, the grip of the cell is released by moving the second member (212) so that the gap between the first member (211) and the second member (212) becomes farther apart, and then, the cell (1) is inserted into the accommodating part (401) of the pouch (400).

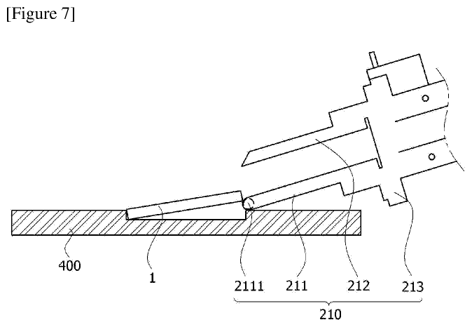

Then, referring to FIG. 6, the control part (40) may tilt the cell grip unit (200) so that the second member (212) is approximately parallel to the pouch (400). Then, referring to FIG. 7, the control part (40) may adjust the position and direction of the cell grip unit (200) so that the cell (1) contacts the roller (2111) in the process of being transferred from the cell grip unit (200) to the pouch (400).

The cell packaging method may comprise a first transport step, a grip step, a second transport step, and an insertion step.

The first transport step is a step of transporting the cell grip unit (200) to the cell on the cell supply part through the transport part (300). The first transport step may be performed by transporting the cell grip unit (200) to the cell (1) using the transport part so that the cell (1) is positioned between the first member (211) and the second member (212).

The grip step is a step of gripping the cell with the cell grip unit (200), which is performed by gripping the cell with the cell grip unit. The grip step may be performed by moving the second member (212) to narrow the gap between the first member (211) and the second member (212) with the gap adjusting part (213) after the cell is seated on the first member (211).

The second transport step is a step of transporting the cell gripped in the grip step to the pouch (400), which is performed by transporting the cell grip unit (200), in which the cell is gripped, toward the pouch using the transport part (300).

The insertion step is a step for inserting the cell (1) into the pouch (400). The inserting step may be performed by transporting the cell to the accommodating part of the pouch, and then moving the second member so that the gap between the first member and the second member becomes farther apart to release the grip of the cell.

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the cell packaging device related to at least one example of the present invention, in the process of inserting the cell into the pouch, it is possible to prevent the damage of the cell, and it is also possible to transport a high-weight cell to the pouch.

1. A cell packing device comprising:
a cell grip unit with a cell grip part and a gap adjusting part, the cell grip part including a first member provided with a roller and a second member disposed opposite to the first member at a predetermined interval to define an insertion space configured to receive a cell, the gap adjusting part configured to adjust a gap between the first member and the second member defining the predetermined interval; and
a transport part configured to transport the cell grip unit.

2. The cell packaging device according to claim 1, wherein the gap adjusting part is configured to adjust the gap by moving the second member.

3. The cell packaging device according to claim 1, wherein the roller is disposed at an entrance of the insertion space configured to receive the cell.

4. The cell packaging device according to claim 1, wherein the transport part is configured to rotate the cell grip unit about a thickness direction or a width direction of the cell during transport of the cell grip unit.

5. The cell packaging device according to claim 1, wherein the transport part: includes
a plurality of rotation parts and links connecting adjacent rotating parts, the rotation parts configured to rotate along a thickness direction and a width direction of the cell.

6. The cell packaging device according to claim 1, further comprising a control part configured to control the cell grip unit and the transport part,
the control part configured to transports the cell grip unit such that a cell on a cell supply part is positioned in the insertion space.

7. The cell packaging device according to claim 6, wherein
the control part is configured to narrow the gap between the first member and the second member after a cell is seated on the first member.

8. The cell packaging device according to claim 7, wherein
the control part is configured to transports the cell grip unit such that a cell on the cell supply part is seated on first member while contacting the roller.

9. The cell packaging device according to claim 7, wherein the control part is configured to transports the cell grip unit such that a partial region of a cell is configured to contacts a pouch when the cell is gripped.

10. The cell packaging device according to claim 9, wherein the control part is configured to release a gripped cell by widening the gap between the first member and the second member when a partial region of the cell contacts a pouch.

11. The cell packaging device according to claim 10, wherein the control part is configured to transports the cell grip unit such that when a gripped cell is released the cell is inserted into a pouch while contacting the roller.

12. The cell packaging device according to claim 1, wherein
the roller is idle-rotatably mounted to the first member.

13. The cell packaging device according to claim 2, wherein
the gap adjusting part is configured to move the second member toward or away from the first member.

14. The cell packaging device according to claim 1, wherein
the cell grip unit includes a support part connected to the transport part,
a plurality of cell grip parts being located on the support part at predetermined intervals.
